(19) United States
(12) Patent Application Publication
(10) Pub. No.: US 2004/0174082 A1
(43) Pub. Date: Sep. 9, 2004

(54) Multiple concentric coil motor

(76) Inventor: Gregory S. Graham, Ventura, CA (US)

Correspondence Address: Michael G. Petit, P.O. Box 91929, Santa Barbara, CA, 93190-1929, US

(21) Appl. No.: 10/378,437

(22) Filed: Mar. 4, 2003

(51) Int. Cl. H02K 21/12

(52) U.S. Cl. 310/156.12

(57) ABSTRACT

An electromotive induction device such as a motor having a stator that includes multiple cylindrical, concentrically mounted coils. The rotor includes multiple cylindrical, concentrically disposed magnets. The multiple coils of the stator are mounted on a stationary mounting plate. The concentric magnets of the rotor are affixed to a rotatably mounted shaft. The multiple coil stator is applicable to both brushed and brushless motors. The interleaved configuration of the multiple rotor magnets and the multiple coils of the stator increases the area of flux interaction between the rotor and stator and the power output of the motor. The electromotive induction device has a stator assembly and a rotor assembly rotatably attached to the stator assembly. The rotor assembly includes a circular rotor mounting plate having an axial drive shaft affixed thereto. A plurality of concentric cylindrical magnets have a free end and a fixed end which is rigidly affixed to the rotor mounting plate and disposed coaxially with respect to the drive shaft. A cylindrical volume is defined between adjacent concentric magnets. The stator comprises a plurality of substantially cylindrical induction coils having a free end and a fixed end rigidly mounted on a stator mounting plate wherein the free end of each of the respective cylindrical coils comprising the stator are disposed to lie within the cylindrical volume between adjacent magnets.

### BACKGROUND OF THE INVENTION

1. Field of the Invention

The present invention relates generally to electromotive devices and, more particularly, to electric motors and generators.

2. Prior Art

Brushless permanent DC motors are becoming increasingly popular, particularly for traction drive systems. Such traction drive systems are employed in vehicles such as golf carts, electric scooters, electric motorcycles, electric cars, hybrid cars, electric outboard motors for boats, etc, and, most recently the electric powered, gyroscopically stabilized scooter referred to in the popular literature as “It”. In such applications, high power density and high efficiency are the primary performance requirements for the driving motor. In order to achieve high power density and high efficiency for such applications, it is critical that the flux interaction between the rotor and the stator be maximized. Accordingly, there is an existing need for an electromotive device that provides a high flux interaction region.

### SUMMARY

It is an overall objective of the present invention to provide an electromotive induction device having increased power output.

The above objective is met by providing an electromotive induction device comprising a stator assembly and a rotor assembly rotatably attached to the stator assembly. The rotor assembly comprises a circular rotor mounting plate having an axial drive shaft affixed thereto and a plurality of substantially concentric cylindrical magnets having a free end and a fixed end rigidly affixed to the rotor mounting plate and disposed coaxially with respect to the drive shaft. A cylindrical volume is defined between adjacent concentric magnets. The stator comprises a plurality of substantially cylindrical induction coils having a free end and a fixed end rigidly mounted on a stator mounting plate wherein the free end of each of the respective cylindrical coils comprising the stator are disposed to lie within a corresponding cylindrical volume between adjacent magnets.

In a preferred embodiment, the electromotive induction device comprises a stator assembly and a rotor assembly rotatably mounted on the stator assembly. The stator assembly comprises a tubular, thin-walled inner inductance coil and a tubular, thin-walled outer inductance coil. Both the inner and outer inductance coils are cylindrical, tubular members having a fixed end that is rigidly and concentrically mounted on a stator mounting face plate, and a free end in opposition to the fixed end. Both the inner and outer inductance coils have a coil thickness and a cylindrical intercoil space separating the inner inductance coil from the outer inductance coil. The rotor assembly, which is rotatably attached to the stator assembly comprises a drive shaft having a fixed end rigidly affixed to a rotor mounting plate and a free end in opposition to the fixed end. The drive shaft has an axial length defining an axis. All componens comprising both the rotor and stator assemblies are mounted such that they are axially symmetric about the axis of the drive shaft. A substantially cylindrical, tubular inner inside back iron has a fixed end rigidly affixed to the rotor mounting plate and a free end in opposition thereto. The inner inside back iron has a cylindrical inner magnet affixed to an outer surface thereof. The cylindrical inner magnet has an outer surface disposed coaxially with and adjacent to an inner surface of the inner inductance coil and is spaced therefrom by a thin gap. A cylindrical, tubular inner return iron has a fixed end rigidly affixed to the rotor mounting plate and a free end in opposition thereto. The inner return iron has an inner surface disposed adjacent to an outer surface of the inner coil and is spaced therefrom by a thin gap.

The rotor assembly comprising the preferred embodiment of the electromotive device further comprises a substantially cylindrical and tubular outer back iron having a fixed end rigidly affixed to the rotor mounting plate and a free end in opposition thereto. The outer back iron is disposed within the intercoil space and has a cylindrical outer surface disposed adjacent to an inner surface of the outer induction coil and separated therefrom by a thin gap. A tubular outer back iron has a fixed end rigidly affixed to the rotor plate and a free end in opposition thereto. A cylindrical outer magnet is affixed to an inner surface of the tubular outer back iron. The cylindrical outer magnet has an inner surface disposed coaxially with, and adjacent to an outer surface of the outer inductance coil and is spaced therefrom by a thin gap.

The features of the invention believed to be novel are set forth with particularity in the appended claims. However the invention itself, both as to organization and method of operation, together with further objects and advantages thereof may be best understood by reference to the following description taken in conjunction with the accompanying drawings in which:

### BRIEF DESCRIPTION OF THE DRAWINGS

FIG. 1 is a longitudinal cross-sectional view of an electric motor in accordance with the present invention.

FIG. 2 is a transverse cross-sectional view of the motor of FIG. 1 taken along section line 2-2.

FIG. 3 is a longitudinal cross-sectional view of an embodiment of an electric motor in accordance with an embodiment of the present invention wherein a pair of concentric coils are mounted to separate concentric drive shafts so as to be counter-rotating.

### DESCRIPTION OF THE PREFERRED EMBODIMENTS

Cylindrical induction coils for use as a stator in an electromotive device are known in the art. For example, the present inventor, in U.S. Pat. No. 6,111,329, discloses such an induction coil. The induction coil is constructed from a pair of precision machined copper plates cut in a pattern to produce a series of axially extending surface conductive bands with each band separated from the other by an insulated cutout. The precision machined plates are rolled to form two telescoping, hollow cylinders with each cylinder having a pattern of conductive bands representing a half-electric circuit. The outer surface of the inner cylinder is wrapped with several layers of fiberglass strands for structural stability and insulation. The fiberglass wrapped inner cylinder is telescoped inside the outer cylinder. The outer surface of the telescoped structure is also wrapped with several layers of fiberglass strands for structural stability. The conductive bands from the outer cylinder being the near mirror image of the conductive bands of the inner cylinder are helically coupled to form a complete electrical circuit. The resulting tubular structure is encapsulated in a potting material for further structural stability and insulation. The result is a freestanding ironless core inductive coil for a motor.

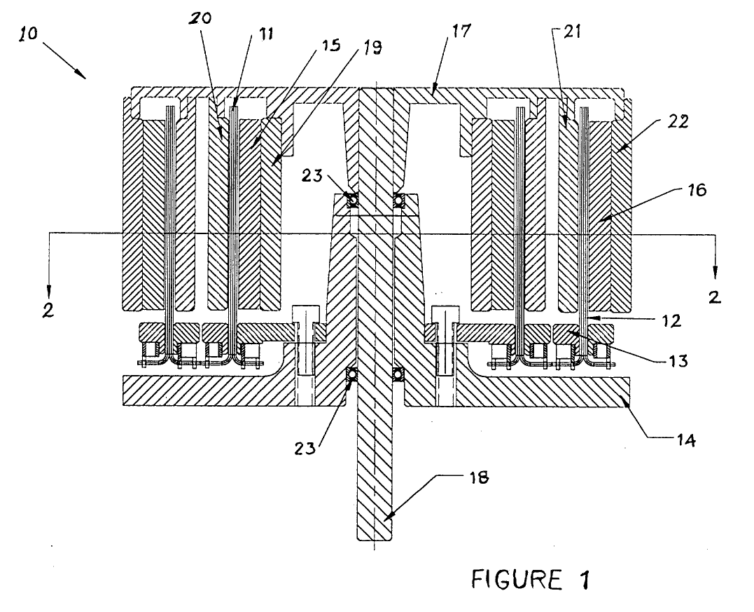

With reference now to FIG. 1, a motor 10 is shown in longitudinal cross-section. The motor 10 has a stator assembly comprising a pair of cylindrical concentrically-mounted induction coils: an inner coil 11, and an outer coil 12, both coils 11 and 12 being rigidly and coaxially mounted on a stator mounting disc 13 which, in turn, is rigidly mounted on a stator mounting face plate 14 by mounting bolts 14a and 14b. The rotor assembly comprises a pair of concentric cylindrical magnets: an inner magnet 15 and an outer magnet 16, coaxially mounted on a rotor mounting plate 17. An output shaft 18 is affixed to the rotor mounting plate 17 and passes through a hole in the stator mounting face plate 14 supported by bearings 23. The rotor assembly further includes four cylindrical iron members: an inner inside back iron 19, an inner return iron 20, an outer back iron 21 and an outer return iron 22. The inner coil 11 and the inner magnet 15 are disposed in the cylindrical gap between the inner inside back iron 19 and the inner return iron 20. Similarly, the outer coil 12 and the outer magnet 16 are concentrically disposed within the cylindrical gap between the outer back iron 21 and the outer return iron 22. The rotor mounting plate 17 is affixed to and supported by the output shaft 18 which, in turn, is rotatably mounted on the stator mounting face plate 14. Bearings 23 provide support for the shaft 18 and permit rotation thereof with respect to the stator mounting face plate 14.

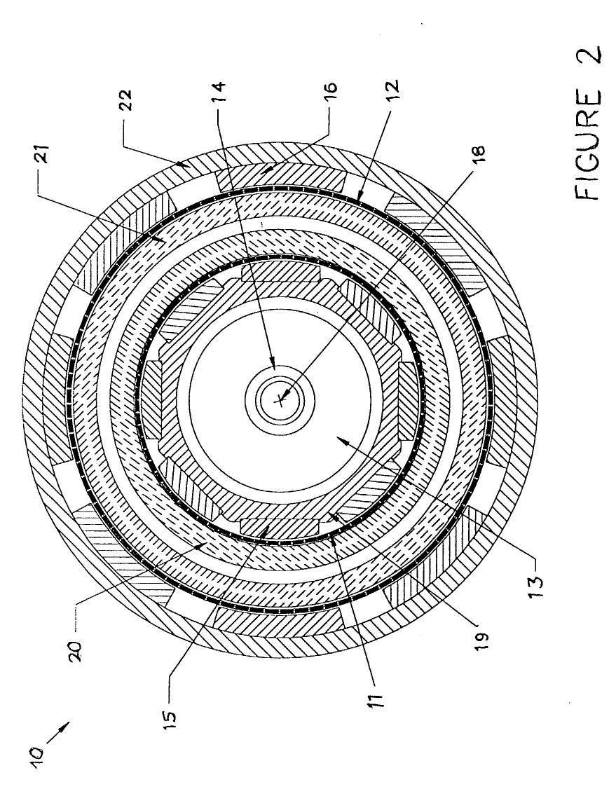

Details of the construction of the induction coils 11 and 12 is set forth in U.S. Pat. No. 6,111,329 to the present inventor, and in copending U.S. patent application Ser. No. 09/982,621, filed Oct. 17, 2001, also to the present inventor. The connection of the inner and outer induction coils 11 and 12 respectively to a current driver via the stator mounting disc 13 is disclosed in copending U.S. patent application Ser. No. 10/125,809, filed Apr. 18, 2002, also by the present inventor. The direction of current through the coils 11 and 12 is determined by Hall effect devices (not shown in FIGS. 1 and 2) disposed on the stator mounting disc 13.

FIG. 2 is a transverse cross-sectional view of the motor 10 of FIG. 1 taken along section line 2-2. Moving outward laterally from the shaft 18, the stator mounting face plate 14 and the stator mounting disc 13, a cylindrical inside back iron 19 has a fixed end affixed to the rotor mounting plate 17 (not visible in FIG. 2) and a free end in opposition thereto. The inside back iron 19, is preferably a cylindrical member comprising a high permeability material such as iron. The inside back iron 19 serves to confine the magnetic flux from the (rotating) inner magnet 15 disposed within the region occupied by the (stationary) inner coil 11 in order to optimize the flux interaction therebetween. One surface of the inner magnet 15 is affixed to outer surface of the (rotating) inside back iron 19. The opposing surface of the magnet 15 is separated from the (stationary) inner coil 11 by a thin gap. The thin, cylindrical gap between the inner coil 11 and the outer surface of the magnet 15 further increases the interaction between the magnetic flux field of the magnet and the inner coil.

With continued reference to FIG. 2, a second thin gap separates the outer surface of the inner coil 11 from the inner surface of a cylindrical inner return iron 20 to yet further increase the magnetic interaction between the inner core 11 and the inner magnet 15 by confining the magnetic flux field to a volume disposed between the outer surface of the back iron 20 and the inner surface of the inner inside back iron 19. The inner inside back iron 19, the magnet 15 and the outer inside back iron 20 are all attached at a fixed end thereof to the rotor mounting plate 17, whereas the inner coil 11 and the outer coil 12 are rigidly mounted on the stator mounting disc 13 which, in turn, is rigidly attached to the stator mounting face plate 14. In a similar manner, the cylindrical outer coil 12 is sandwiched between an outer back iron 21 and a cylindrical outer magnet 16 with a small, extremely thin gap separating the coil from the aforesaid adjacent concentric members. The thin gap, together with the outer back iron 21 and the outer return iron 22, again serves to optimize the magnetic flux interaction between the stationary outer coil 12 and the rotating outer magnet 16.

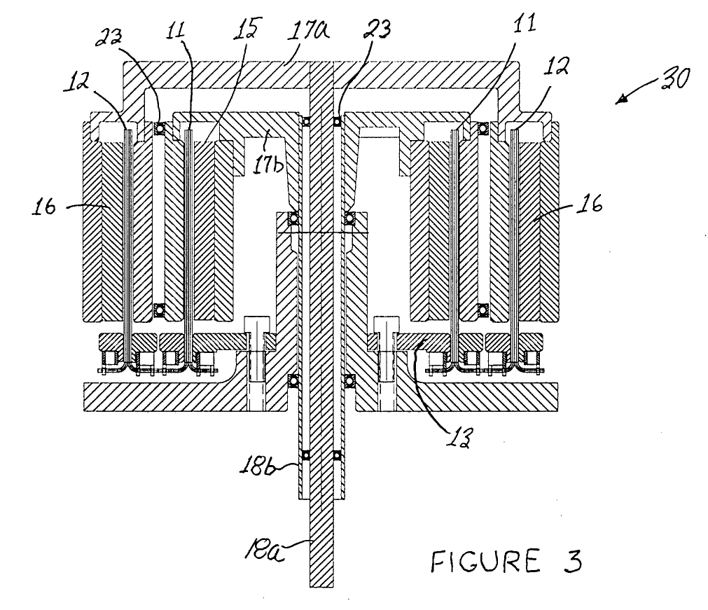

Turning now to FIG. 3, a counter-rotating motor 30 is shown in longitudinal cross-sectional view wherein the cylindrical outer magnet 16 is mounted on a first rotor mounting plate 17a and the cylindrical inner magnet 15 is mounted on a second rotor mounting plate 17b. Each rotor mounting plate 17a and 17b rotate independently and have respective output drive shafts 18a and 18b affixed axially thereto and spaced from one another by bearings 23. The counter-rotating motor configuration shown at 30 may be employed to increase the relative angular velocity of the two output drive shafts 18a and 18b for applications requiring such a high relative velocity. In addition, one of the drive shafts can be used as a mechanical drive while the other drive shaft can be used in a generator application.

While particular embodiments of the present invention have been illustrated and described, it would be obvious to those skilled in the art that various other changes and modifications can be made without departing from the spirit and scope of the invention. For example, it is possible to mount the inner and outer coils on the rotor plate and the magnets and return irons on the stator plate. Similarly, more than two coils can be employed in the manner described to provide a motor having three or more coils: each of the coils sandwiched between a magnet and a return iron and separated therefrom by a thin gap. It is therefore intended to cover in the appended claims all such changes and modifications that are within the scope of this invention.

What I claim is:

1. An electromotive device comprising:
(a) a stator assembly comprising an inner inductance coil and an outer inductance coil, each of said inner and outer inductance coils being cylindrical tubular members having a fixed end rigidly and concentrically mounted on a stator mounting face plate, and a free end in opposition to said fixed end, a coil thickness and a cylindrical intercoil space separating said inner inductance coil from said outer inductance coil; and
(b) a rotor assembly rotatably attached to said stator assembly comprising a drive shaft having a fixed end rigidly affixed to a rotor mounting plate and a free end in opposition to said fixed end, said drive shaft having an axial length defining an axis; a substantially cylindrical inner inside back iron having a fixed end rigidly affixed to said rotor mounting plate and a free end in opposition thereto and a cylindrical inner magnet affixed to an outer surface of said inner inside back iron, said cylindrical inner magnet having an outer surface disposed coaxially with and adjacent to an inner surface of said inner inductance coil and spaced therefrom by a thin gap; and a cylindrical inner return iron having a fixed end rigidly affixed to said rotor plate and a free end in opposition thereto, said inner return iron having an inner surface disposed adjacent to an outer surface of said inner coil and spaced therefrom by a thin gap.

2. The electromotive device of claim 1 wherein said rotor assembly further comprises a substantially cylindrical outer back iron having a fixed end rigidly affixed to said rotor mounting plate and a free end in opposition thereto, said outer back iron disposed within said intercoil space and having an outer surface disposed adjacent to an inner surface of said outer induction coil and separated therefrom be a thin gap, a tubular outer back iron having a fixed end rigidly affixed to said rotor plate and a free end in opposition thereto, and a cylindrical outer magnet affixed to an inner surface of said tubular outer back iron, said cylindrical outer magnet having an inner surface disposed coaxially with and adjacent to an outer surface of said outer inductance coil and spaced therefrom by a thin gap.

3. An electromotive device comprising:
(a) a stator assembly comprising an inner inductance coil and an outer inductance coil, each of said inner and outer inductance coils being cylindrical tubular members having a fixed end rigidly and concentrically mounted on a stator mounting face plate, and a free end in opposition to said fixed end, a coil thickness and a cylindrical intercoil space separating said inner inductance coil from said outer inductance coil; and
(b) two independent rotor assemblies rotatably attached to said stator assembly, each of said independent rotor assemblies comprising a drive shaft having a fixed end rigidly affixed to a rotor mounting plate and a free end in opposition to said fixed end, said drive shaft having an axial length defining an axis; a substantially cylindrical inner inside back iron having a fixed end rigidly affixed to said rotor mounting plate and a free end in opposition thereto and a cylindrical inner magnet affixed to an outer surface of said inner inside back iron, said cylindrical inner magnet having an outer surface disposed coaxially with and adjacent to an inner surface of said inner inductance coil and spaced therefrom by a thin gap; and a cylindrical inner return iron having a fixed end rigidly affixed to said rotor plate and a free end in opposition thereto, said inner return iron having an inner surface disposed adjacent to an outer surface of said inner coil and spaced therefrom by a thin gap.
